(19) United States
(12) Patent Application Publication
(10) Pub. No.: US 2009/0111499 A1
(43) Pub. Date: Apr. 30, 2009

(54) METHOD OF MODIFYING PILOT POWER FOR A HOME BASE STATION ROUTER BASED ON USER DEMAND

(76) Inventors: PETER BOSCH, New Providence, NJ (US); HOLGER CLAUSSEN, Swindon (GB); LESTER T.W. HO, Swindon (GB); LOUIS G. SAMUEL, Swindon (GB)

Correspondence Address: MARK W. SINCELL;Williams, Morgan & Amerson, P.C., Suite 1100, 10333 Richmond, Houston, TX, 77042, US

(21) Appl. No.: 11/877,769

(22) Filed: Oct. 24, 2007

(51) Int. Cl. H04Q 7/30

(52) U.S. Cl. 455/522

(57) ABSTRACT

The present invention provides a method implemented in a base station router. One embodiment of the method includes determining a transmission power for a pilot signal transmitted by the base station router. The transmission power being determined based upon a number of mobile units that are camped on the base station router. Another embodiment of the method includes deploying the first base station router in a physical structure and estimating the dimensions of the physical structure based on a statistical representation of at least one handover attempt associated with the first base station router. Estimation of the dimensions of the physical structure occurs in response to deployment of the first base station router in the physical structure.

### CROSS REFERENCE TO RELATED APPLICATIONS

This application is related to “U.S. patent application Ser. No. 11/771,644, entitled “Method of Automatically Configuring a Home Base Station Router” filed on 29^{th} Jun., 2007, herein incorporated by reference in its entirety for all purposes.”

### BACKGROUND OF THE INVENTION

1. Field of the Invention

This invention relates generally to communication systems, and, more particularly, to wireless communication systems.

2. Description of the Related Art

Conventional wireless communication systems use a network of base stations to provide wireless connectivity to one or more mobile units. In some cases, the mobile units may initiate wireless communication with one or more base stations in the network, e.g., when the user of the mobile unit would like to initiate a voice or data call. Alternatively, the network may initiate the wireless communication link with the mobile unit. For example, in conventional hierarchical wireless communications, a server transmits voice and/or data destined for a target mobile unit to a central element such as such as a Radio Network Controller (RNC). The RNC may then transmit paging messages to the target mobile unit via one or more base stations. The target mobile unit may establish a wireless link to one or more of the base stations in response to receiving the page from the wireless communication system. A radio resource management function within the RNC receives the voice and/or data and coordinates the radio and time resources used by the set of base stations to transmit the information to the target mobile unit. The radio resource management function can perform fine grain control to allocate and release resources for broadcast transmission over a set of base stations.

One alternative to the conventional hierarchical network architecture is a distributed architecture including a network of access points, such as base station routers, that implement distributed communication network functionality. For example, each base station router may combine RNC and/or PDSN functions in a single entity that manages radio links between one or more mobile units and an outside network, such as the Internet. Base station routers wholly encapsulate the cellular access technology and may proxy functionality that utilizes core network element support to equivalent IP functions. For example, IP anchoring in a UMTS base station router may be offered through a Mobile IP Home Agent (HA) and the GGSN anchoring functions that the base station router proxies by through equivalent Mobile IP signaling. Compared to hierarchical networks, distributed architectures have the potential to reduce the cost and/or complexity of deploying the network, as well as the cost and/or complexity of adding additional wireless access points, e.g. base station routers, to expand the coverage of an existing network. Distributed networks may also reduce (relative to hierarchical networks) the delays experienced by users because packet queuing delays at the RNC and PDSN of hierarchical networks may be reduced or removed.

At least in part because of the reduced cost and complexity of deploying a base station router, base station routers may be deployed in locations that are impractical for conventional base stations. For example, a base station router may be deployed in a residence or building to provide wireless connectivity to the occupants of the residents of the building. Base station routers deployed in a residence are typically referred to as home base station routers because they are intended to provide wireless connectivity to a micro-cell that encompasses a residence. However, the functionality in a home base station router is typically quite similar to the functionality implemented in a conventional base station router that is intended to provide wireless connectivity to a macro-cell that may cover an area of approximately a few square kilometers. One important difference between a home base station router and a conventional base station router is that home base station routers are designed to be plug-and-play devices that can be purchased off-the-shelf and easily installed by a lay person.

Deployment of home base station routers may result in a very large number of femtocells, which may overlap with or be encompassed by one or more macro-cells. The presence of the femtocells may disrupt the careful cell planning and optimization used to configure the macro-cells. For example, if a mobile unit that is camped on a macro-cell passes into an overlapping femtocells, the mobile unit may send a message requesting that the femtocell be added to the mobile unit's active set. The resources for a potential soft or hard handoff to the femtocell may then be allocated to the mobile unit. Consequently, the presence of a large number of femtocells may undesirably increase the signaling overhead of the wireless communication network. One possible solution to this problem is to have a technician perform cell optimization for every home base station router. However, this approach would be very costly and run contrary to the goal of making home base station routers function as plug-and-play devices.

The frequency of handovers can be reduced by configuring the pilot power such that it provides the best compromise between indoor coverage and spilling outside of the house. However this solves the problem only partially since for a typical house it is not possible to select the pilot such that it covers the whole house without spillage out of the windows. Typical examples are shown in FIG. 1A (for coverage in idle mode) and in FIG. 1B (for coverage in active mode). Each figure shows a contour plot of the pilot signal strength of a femtocell that is optimized such that it covers the inside of a house reasonably well. The area covered by the femtocell is colored to indicate the received signal strength in dB and white areas are covered by an overlapping macrocell associated with another base station router. The colored figure indicates that the signal strength is highest near the femtocell and decreases away from the femtocell. Shadowing by obstacles such as walls also decreases the signal strength. In this example it is assumed that a handover is triggered when the signal strength of the received pilot signal transmitted by the home base station router that serves the femtocell is 4 dB higher (for active mode) and 2 dB higher (for idle mode) than the signal strength of the received pilot signal transmitted by the home base station router that serves the overlapping macrocell. The femtocell pilot signal spills out of the house through windows so that a user walking past the house would camp on or handover to the femtocell. FIGS. 2A and 2B show contour plots that indicates the corresponding coverage by the overlapping macrocell in idle and active modes, respectively.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for implementation in a base station router. The method includes determining a transmission power for a pilot signal transmitted by the base station router. The transmission power being determined based upon a number of mobile units that are camped on the base station router.

In another embodiment of the present invention, a method is provided for implementation in a first base station router. The method includes deploying the first base station router in a physical structure and estimating the dimensions of the physical structure based on a statistical representation of at least one handover attempt associated with the first base station router. Estimation of the dimensions of the physical structure occurs in response to deployment of the first base station router in the physical structure.

### BRIEF DESCRIPTION OF THE DRAWINGS

The invention may be understood by reference to the following description taken in conjunction with the accompanying drawings, in which like reference numerals identify like elements, and in which:

FIGS. 1A and 1B show contour plots that indicates the coverage by a femtocell served by a home base station router in idle and active modes, respectively;

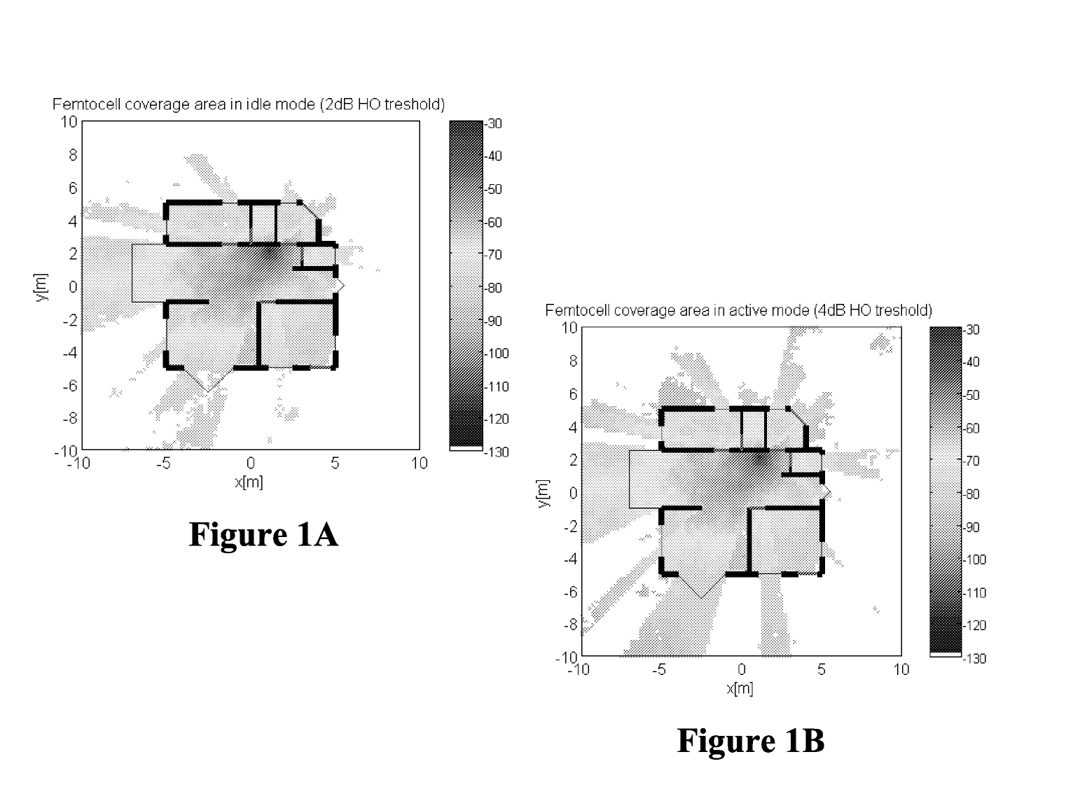

FIGS. 2A and 2B show contour plots that indicate coverage by an overlapping macrocell associated with another base station router in idle and active modes, respectively;

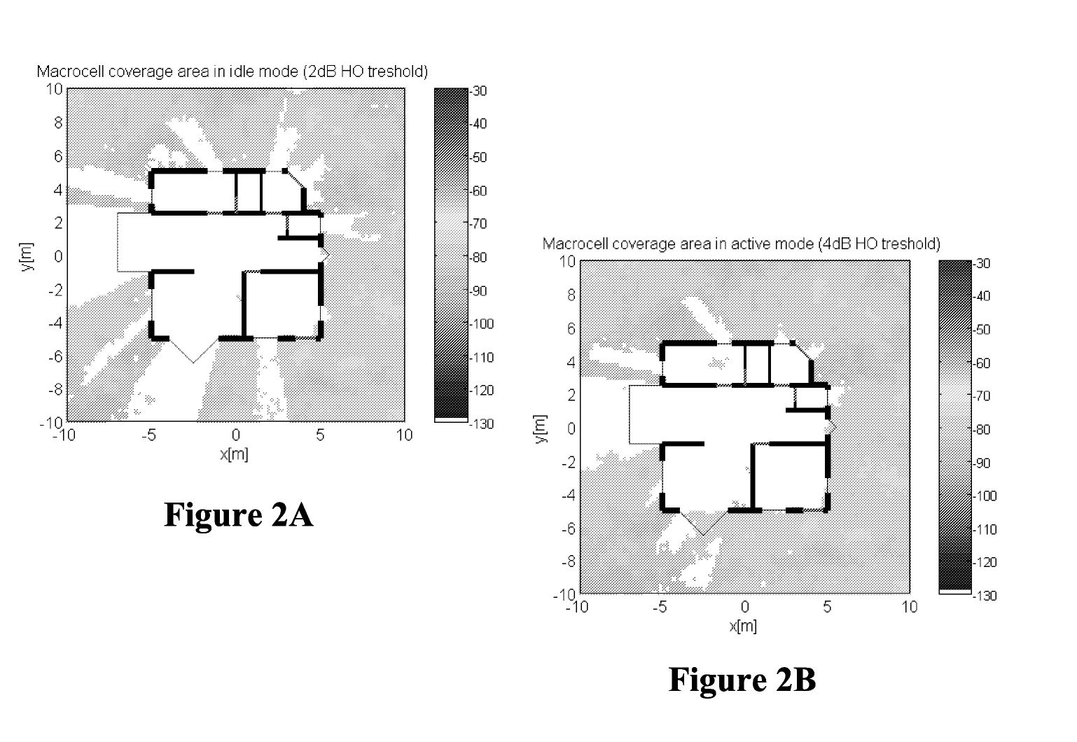

FIG. 3 conceptually illustrates one exemplary embodiment of a wireless communication system, in accordance with the present invention;

FIG. 4 conceptually illustrates one exemplary embodiment of a method of adjusting a pilot power strength used by a home base station router that is deployed within a building;

FIGS. 5A and 5B depict one exemplary embodiment of the coverage area of a home base station router operating in a reduced power mode for idle and active modes, respectively; and

FIGS. 6A and 6B depict the corresponding coverage areas of a macrocell when the home base station router is operating in the reduced power mode for idle and active modes, respectively.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

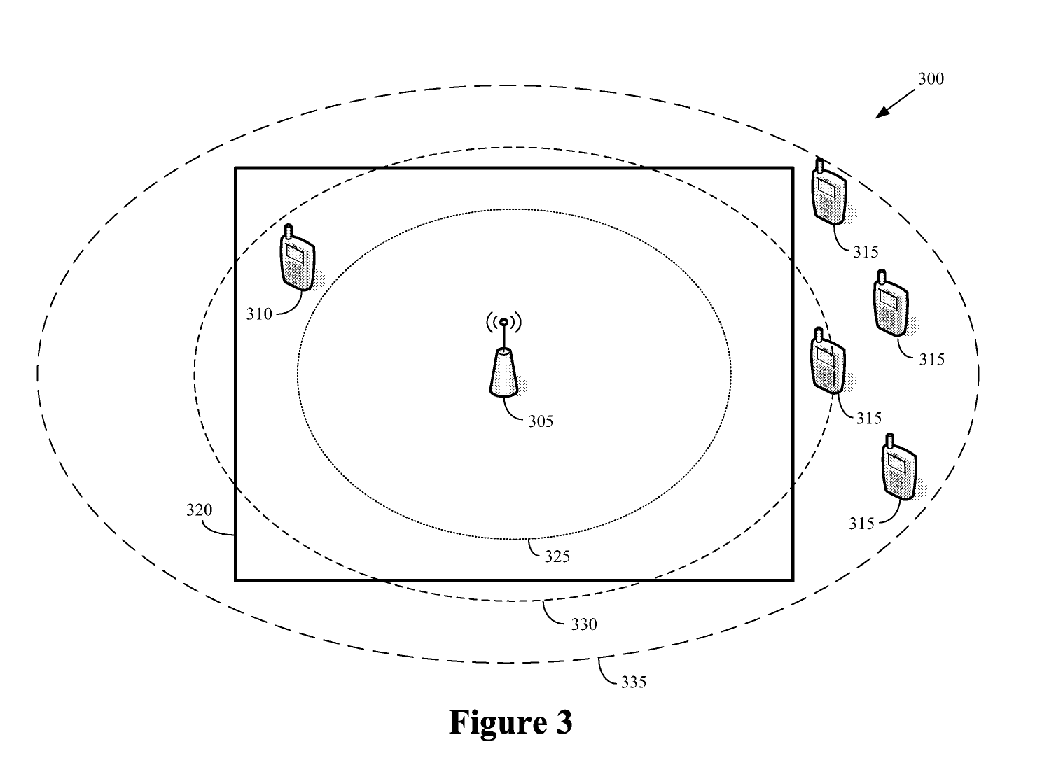

FIG. 3 conceptually illustrates one exemplary embodiment of a wireless communication system 300. In the illustrated embodiment, the wireless communication system 300 includes one or more home base station routers 305 for providing wireless connectivity. The home base station router 305 may provide wireless connectivity according to standards and/or protocols including, but not limited to, Universal Mobile Telecommunication Services (UMTS) standards and/or protocols, Global System for Mobile communication (GSM) standards and/or protocols, WiMAX standards and/or protocols, IEEE standards and/or protocols, and the like. Furthermore, persons of ordinary skill in the art having benefit of the present disclosure should appreciate that the present invention is not limited to using home base station routers 305 to provide wireless connectivity. In alternative embodiments, devices such as base stations, base station routers, access points, access networks, and the like may be used to provide wireless connectivity in the wireless communication system 300.

The home base station router 305 is configured to transmit a pilot signal at a selected transmission power. Mobile units 310, 315 that are proximate to the home base station router 305 may detect the transmitted pilot signal and use the pilot signal to determine whether the home base station router 305 may be selected as a serving home base station router 305. For example, a mobile unit 310, 315 that detects and successfully decodes the pilot signal transmitted by the home base station router 305 may handoff to the home base station router 305 and/or other base station routers, either by a hard handoff from one base station router to another or by a soft handoff in which the mobile units 310, 315 are in concurrent communication with multiple base stations. In alternative embodiments, the mobile units 310, 315 may also trigger other active or idle mode events (including active mode mobility-related events and idle mode camping events) using mobility-related procedure requests that are transmitted to the home base station router 305. Techniques for transmitting pilot signals, detecting the presence of base station routers using the pilot signals, adding base station routers to an active list, and handing off between base station routers are known in the art and in the interest of clarity only those aspects of these procedures that are relevant to the present invention will be discussed herein.

The home base station router 305 is intended to provide coverage to an area that approximately encompasses a building 320 that includes one or more mobile units 310 that are registered with the home base station router 305. The mobile units 310 may be registered with the home base station router 305 using a variety of techniques including having a user enter an International Mobile Subscriber Identity (IMSI) for the registered mobile units 310 via a webpage, using a handshaking protocol between the mobile units 310 and the home base station router 305, and the like. The particular technique for registering the mobile units 310 is a matter of design choice and not material to the present invention. A list of the registered mobile units 310 is then made available to the home base station router 305. In one embodiment, the home base station router 305 contains a database including the IMSI values for the registered mobile units 310.

The transmission power of the pilot signal transmitted by the home base station router 305 should be large enough to provide a pilot signal strength that is strong enough to be detected by registered mobile units 310 within the building 320 but not so large that unregistered mobile units 315 outside of the building 320 request a large number of handovers to the home base station router 305. For example, if the pilot signal transmission power is set to a relatively low value, then the coverage area 325 may not be large enough to provide wireless connectivity to the registered mobile unit 310 and/or to keep an idle mobile unit 310 camped on the home base station router 305. Increasing the pilot signal transmission power may allow the home base station router 305 to provide wireless connectivity to a larger coverage area 330 that allows the registered mobile unit 310 to contact and/or remain camped on the home base station router 305. However, if the pilot signal transmission power is increased to reach the coverage area 335, a large number of unregistered mobile units 315 may begin to request handovers to the home base station router 305.

The pilot signal strength that is appropriate for the building 320 may depend on whether or not any registered mobile units 310 are present in the building. In one embodiment, when there are no registered mobile units 310 in the building 320, the pilot signal strength may be reduced so that leakage of the pilot signal outside of the building 320 is correspondingly reduced. Reducing the leakage of the pilot signal may therefore reduce the number of handover requests between the home base station router 305 and other base station routers that may provide overlapping coverage. The home base station router 305 may also elect to transmit the pilot signal only during selected time intervals, e.g. once every two minutes, when there are no registered mobile units 310 in the building 320. Intermittent transmissions of the pilot signal may be at the reduced signal strength or at full strength. The pilot signal strength may be increased when the home base station router 305 detects the presence of one or more registered mobile units 310. In one embodiment, the pilot signal strength may be increased to a predetermined value when one or more registered mobile units 310 are present within the building 320.

The pilot signal strength used in the presence of registered mobile units 310 may alternatively be determined based upon the activity mode of the mobile units 310. For example, when one or more registered mobile units 310 have an active communication session with the home base station router 305 (e.g., the registered mobile units 310 are in the active mode), the pilot signal strength may be set to a predetermined level. However, when one or more of the registered mobile units 310 are in the idle mode and do not have an active communication session with the home base station router 305, the pilot signal strength may be set at a level that is larger than the minimum level used in the absence of any registered mobile units 310. The selected pilot signal strength may also be smaller than the level that is used when active mobile units 310 are present. In cases where multiple registered mobile units 310 are present and some of the mobile units 310 are in the active mode and other mobile units 310 are in the idle mode, the pilot signal strength may be determined using algorithms that balance the demand for providing reliable high-quality communication and the desire limit the number of handovers requested by unregistered mobile units 315 that are outside of the building 320.

In one embodiment, the pilot signal strength may be increased to a value that is determined based on path-losses associated with the registered active mobile units 310. For example, each active mobile unit 310 may report a downlink channel quality associated with the air interface between the mobile unit 310 and the home base station router 305. The home base station router 305 may use the channel quality information reported by the active mobile units 310 to determine the transmission power of the pilot signal. For example, the required pilot power may be determined based upon the registered mobile unit 310 that has the largest path-loss from among the registered mobile units 310 that have an active communication session with the home base station router 305. However, persons of ordinary skill in the art having benefit of the present disclosure should appreciate that other techniques may be used to determine the pilot signal strength based upon the channel quality information. For example, the required pilot power may be determined based on the mean path-loss associated with downlink transmissions to the registered mobile units 310.

The pilot signal strength that is appropriate for the building 320 may also depend on the size and configuration of the building 320. For example, the pilot signal strength that is appropriate for a one-bedroom condominium in a residential high rise may be significantly different than the pilot signal strength that is appropriate for an office building including 40 offices. Furthermore, the pilot signal strength that is appropriate for the building 320 may vary in time due to factors such as relocation of the home base station router 305 within the building 320, changes in the environment inside and/or outside of the building 320, variations in the density of mobile units 310, 315 near the building 320, and the like. Accordingly, the home base station router 305 may use a statistical representation of the distribution of the registered mobile units 310 to determine the pilot signal strength and/or the radiation pattern used to transmit the pilot signal. For example, the home base station router 305 may collect statistical information from previous handover requests by the registered mobile units 310 to determine a statistical representation of the distribution of the registered mobile units 310. This representation may vary over time, for at least the reasons discussed above, and so the pilot signal strength and/or the radiation pattern may be adjusted dynamically. In some embodiments, the home base station router 305 may also collect statistical information from active mode events like previous handover requests by non-registered mobile units, e.g., mobile units 315 that pass by the building 320, and idle mode events such as idle mode camping events to determine a statistical representation of the distribution of the non-registered mobile units 315. The statistical representation of the distribution of the non-registered mobile units 315 may also be used to map the boundaries of the building 320 and to determine the pilot signal strength and/or the radiation pattern used to transmit the pilot signal.

In some cases, registered mobile units 310 within the building 320 may detect pilot signals from nearby macro-cells (not shown in FIG. 3) that may be stronger than the pilot signal transmitted by the home base station router 305. However, it may be preferable for registered mobile units 310 that are already camped on the home base station router 305, or which have recently entered the building 320 and should be camped on the home base station router 305, to remain camped on the home base station 305 even though the pilot signals from nearby macro-cells are stronger. The home base station router 305 may therefore modify handover thresholds (e.g., the threshold value of the received pilot signal strength ratios at which a mobile unit 310 will hand off from the home base station router 305 to an overlapping macrocell) of the registered mobile units 310 so that these mobile units 310 remain camped on the home base station router 305 even when pilot signal strengths associated with overlapping macrocells are relatively stronger. In one embodiment, the home base station router 305 may modify a cell re-selection threshold value that indicates the received pilot signal strength ratios at which an idle mobile unit 310 will hand off from the home base station router 305 to an overlapping macrocell. Modifying the handover thresholds in this manner may permit the home base station router 305 to operate with a reduced pilot signal power when idle registered mobile units 310 are camped on the associated femtocell. The pilot signal power may then be increased when the idle registered mobile units 310 enter the active mode so that a reliable connection (e.g., a connection with sufficient strength to allow channel estimates) may be established.

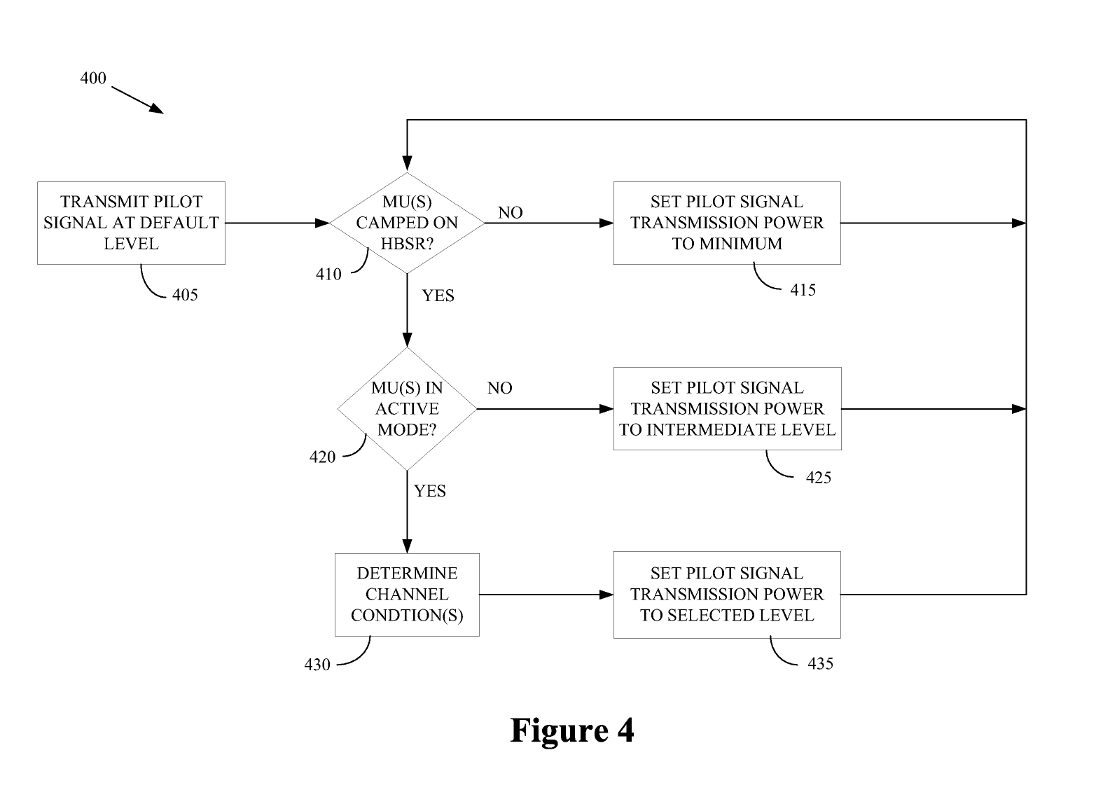

FIG. 4 conceptually illustrates one exemplary embodiment of a method 400 of adjusting a pilot power strength used by a home base station router that is deployed within a building. In the illustrated embodiment, the home base station router initially transmits (at 405) a pilot signal at a default pilot signal transmission power. The pilot signal transmission power may be set to the default value when the home base station router is initially powered up. The pilot signal transmission power may also be set to the default value when the home base station router is relocated to another location or in response to detecting an error condition. Alternatively, the pilot signal transmission power may also be set to the default value in response to resetting or rebooting the home base station router, as well as in response to resetting, rebooting, powering down, or powering up other entities such as other computers that are used to manage the home base station router. The default power level is a matter of design choice and not material to the present invention. However, it is envisioned that the default power level may be selected based on a determination of a typical deployment scenario for the home base station router.

The home base station router may then determine (at 410) whether any mobile units (MUs) are camped on the home base station router (HBSR). If no mobile units are currently camped on the home base station router, then the home base station router may set (at 415) the pilot signal transmission power to a predetermined minimum level. In one embodiment, the pilot power may be reduced (at 415) from the default value (or another current value of the pilot signal power) to a value which provides less coverage internal to the building but which reduces the areas outside of the house where mobile units may determine that the signal strength of the received femtocell pilot is stronger than pilot signal strengths of received macrocell pilot signals (e.g., the home base station router may optimally adapt the pilot power to be substantially retained within the building). For example, if no mobile units are camping on the femtocell, the home base station router may reduce the pilot signal transmission power automatically by, for example, 13 dB. The reduction in the pilot signal transmission power can be a variable value that is optimally calculated given the past history of handover attempts that the femtocell sees over given period of time.

In one embodiment, the home base station router may also determine that the pilot signal does not need to be transmitted continuously because the HBSR has determined (at 410) that no mobile units are camped on the HBSR. The pilot signal transmission power may then be reduced (at 415) by periodically or intermittently transmitting the pilot signal at the reduced (or, in some cases, the full) transmission power level. Persons of ordinary skill in the art having benefit of the present disclosure should appreciate that the time interval during which the pilot signal is transmitted and/or the time interval during which the pilot signal is not transmitted are matters of design choice. The home base station router may then continue to monitor received signals to determine (at 410) whether any mobile units are camped on the home base station router.

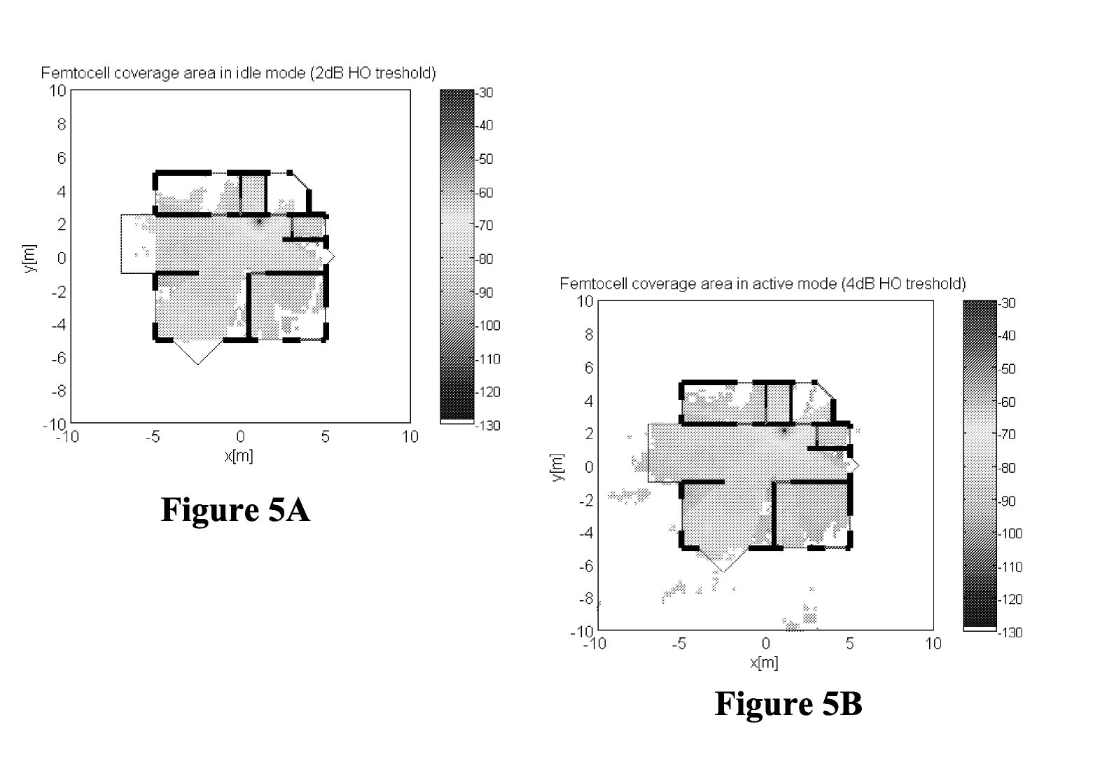

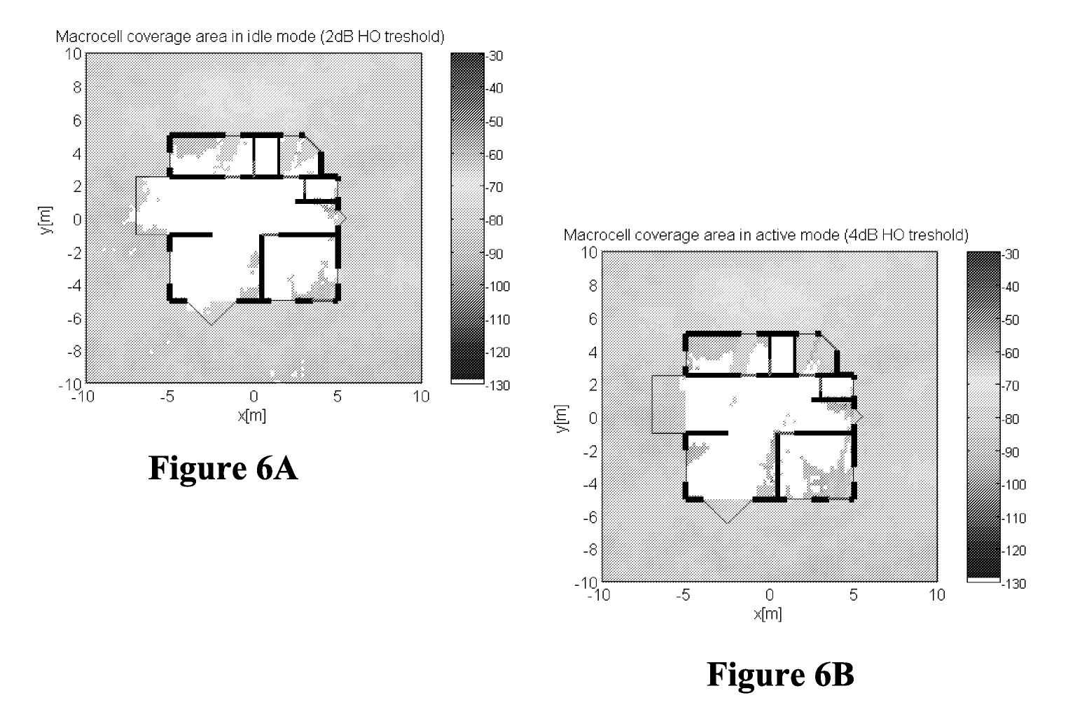

FIGS. 5A and 5B depict one exemplary embodiment of the coverage area of a home base station router operating in a reduced power mode for idle and active modes, respectively. In both cases, the reduction in the pilot signal transmission power results in the coverage area being substantially contained within the boundaries of the building that houses the home base station router. The handover/camping thresholds in the active mode have been set at a slightly higher level than in the idle mode, and therefore the coverage within the building is more complete in the active mode than in the idle mode. In the illustrated embodiment, the handover thresholds for the idle mode and the active mode are 2 dB and 4 dB, respectively. FIGS. 6A and 6B depict the corresponding coverage areas of a macrocell when the home base station router is operating in the reduced power mode for idle and active modes, respectively.

Referring back to FIG. 4, if the home base station router determines (at 410) that one or more mobile units are camped on the home base station router, then the home base station router may determine (at 420) the activity modes or states of the camped mobile units. If the home base station router determines (at 420) that the mobile units camped on the femtocell are in the idle mode, then the home base station router may set (at 425) the pilot signal transmission power to an intermediate level that is above the minimum pilot signal transmission power level. The home base station router may then continue to monitor received signals to detect (at 410) any changes in the number of mobile units that are camped on the home base station router.

If the home base station router determines (at 420) that one or more of the mobile units is in the active mode and has an active communication session with the home base station router, then the home base station router may determine (at 430) one or more channel conditions associated with one or more channels between the home base station router and the mobile units. Exemplary channel conditions may include quality of service levels, signal-to-interference-plus-noise levels, bit error rates, and the like. The home base station router may then set (at 435) the pilot signal transmission power to a level that is determined using the measured channel conditions. For example, the pilot signal transmission power may be set to a relatively low level when the measured channel conditions are relatively good and the pilot signal transmission power may be set to a relatively high level when the measured channel conditions are relatively poor. In cases where there are multiple active mobile units that have active communication sessions with the home base station router, various algorithms may be used to select the pilot signal transmission power based upon the measured channel conditions associated with the active mobile units. The home base station router may then continue to monitor received signals to detect (at 410) any changes in the number of mobile units that are camped on the home base station router.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method implemented in a first base station router, comprising:
determining a transmission power for a pilot signal transmitted by the first base station router, the transmission power being determined based upon a number of mobile units that are camped on the first base station router.

2. The method of claim 1, wherein determining the transmission power for the pilot signal comprises selecting a minimum value of the transmission power based upon dimensions of a physical structure that contains the first base station router.

3. The method of claim 2, wherein determining the transmission power for the pilot signal comprises setting the transmission power at the selected minimum value when no mobile units are camped on the first base station router.

4. The method of claim 3, wherein determining the transmission power for the pilot signal comprises selecting a radiation pattern for transmitting the pilot signal based upon the dimensions of the physical structure that contains the first base station router.

5. The method of claim 3, comprising estimating the dimensions of the physical structure based on a statistical representation of at least one handover attempt associated with the first base station router.

6. The method of claim 1, comprising transmitting the pilot signal at the determined transmission power during selected time intervals.

7. The method of claim 6, comprising selecting the time interval for transmitting the pilot signal at the determined transmission power.

8. The method of claim 2, wherein determining the transmission power for the pilot signal comprises setting the transmission power at a value that is higher than the selected minimum value when at least one mobile unit is camped on the first base station router.

9. The method of claim 8 wherein determining the transmission power for the pilot signal comprises selecting a value for the transmission power based upon at least one path-loss condition associated with at least one channel of at least one air interface between the first base station router and said at least one mobile unit.

10. The method of claim 8, wherein determining the transmission power for the pilot signal comprises determining the transmission power for the pilot signal based upon at least one activity mode of said at least one mobile unit.

11. The method of claim 10, wherein determining the transmission power for the pilot signal comprises decreasing the transmission power when said at least one mobile unit is in an idle mode and increasing the transmission power when said at least one mobile unit is in an active mode.

12. The method of claim 8, comprising modifying at least one handover threshold for said at least one mobile unit when said at least one mobile unit camps on the first base station router.

13. The method of claim 12, wherein modifying said at least one handover threshold comprises modifying said at least one cell re-selection threshold such that said at least one mobile unit remains camped on the first base station router when a pilot signal strength associated with at least one second base station router exceeds the pilot signal strength associated with the first base station router.

14. A method implemented in a first base station router, comprising:
deploying the first base station router in a physical structure; and
estimating, in response to deployment of the first base station router in the physical structure, the dimensions of the physical structure based on a statistical representation of at least one active or idle mode event associated with the first base station router.

15. The method of claim 14, comprising determining a transmission power for a pilot signal transmitted by the first base station router, the transmission power being determined based upon a number of mobile units that are camped on the first base station router and the estimated dimensions of the physical structure.

16. The method of claim 15, wherein determining the transmission power for the pilot signal comprises selecting a minimum value of the transmission power based upon the estimated dimensions of the physical structure and setting the transmission power at the selected minimum value when no mobile units are camped on the first base station router.

17. The method of claim 15, wherein determining the transmission power for the pilot signal comprises selecting a radiation pattern for transmitting the pilot signal based upon the estimated dimensions of the physical structure.

18. The method of claim 15, comprising selecting a time interval for transmitting the pilot signal when no mobile units are camped on the first base station router and transmitting the pilot signal at the selected transmission power during the selected time intervals.

19. The method of claim 16, wherein determining the transmission power for the pilot signal comprises setting the transmission power at a value that is higher than the selected minimum value when at least one mobile unit is camped on the first base station router, decreasing the transmission power when said at least one mobile unit is in an idle mode, and increasing the transmission power when said at least one mobile unit is in an active mode.

20. The method of claim 14, wherein estimating the dimensions of the physical structure comprises determining the statistical representation of at least one active or idle mode event based on handover attempts performed by at least one of mobile unit that is registered with the first base station router or an unregistered mobile unit.
